(19) United States
(12) Patent Application Publication
(10) Pub. No.: US 2004/0204012 A1
(43) Pub. Date: Oct. 14, 2004

(54) Folding mobile phone

(76) Inventor: Takashi Kakinuma, Tokyo (JP)

Correspondence Address: JOHN S. PRATT, ESQ, KILPATRICK STOCKTON, LLP, 1100 PEACHTREE STREET, ATLANTA, GA, 30309, US

(21) Appl. No.: 10/324,180

(22) Filed: Dec. 19, 2002

(30) Foreign Application Priority Data
Jul. 16, 2002 (JP) JP2002-206910

(51) Int. Cl. H04B 1/38; H04M 1/00

(52) U.S. Cl. 455/550.1; 455/90.1

(57) ABSTRACT

In a folding mobile phone 1, a second main body 5 is provided for folding by a hinge mechanism 7 to a first main body 3 and a second loud speaker 15 is disposed in a predetermined position and is turned on by a switch 21 when the phone 1 is folded such that the phone 1 can also be used in the folded state. Furthermore, by providing a second operating section in which a microphone, a power on button, a power off button, and the like are disposed to a portion exposed in the folded state, it is possible to make an outgoing call in the folded state.

### BACKGROUND OF THE INVENTION

1. Field of the Invention

The present invention relates to a folding mobile phone and particularly to a folding mobile phone having an earpiece, a microphone, a power on/off button, an external display panel, and the like such that the phone can be used in two states, i.e., a folded state and an open state.

2. Description of the Related Art

A related folding mobile phone is designed such that a telephone conversation, sending of e-mail, and the like are possible only in an open state of the phone and the phone cannot be used in the folded state. This is because a microphone, a loud speaker, and the like are hidden inside the folded mobile phone when the phone is folded.

### SUMMARY OF THE INVENTION

With a folding mobile phone according to related art, it is inconvenient not to be able to have a telephone conversation when the phone is in a folded state. Because the mobile phone is normally carried by a user, where and when the mobile phone is used are not limited. If the user gets an incoming call in walking, the user can have a phone conversation only after opening the folded mobile phone and it takes time and effort to have the phone conversation. It is also inconvenient to open the folding mobile phone to have the phone conversation in a narrow place or the like.

To solve the above problem, according to a first aspect of the present invention, there is provided a folding mobile phone comprising: a first main body; a second main body provided for opening and closing by a hinge mechanism onto the first main body and having a display; a first loud speaker provided in such a position as to be used when the mobile phone is open; a second loud speaker provided in such a position as to be used when the mobile phone is closed; and a microphone provided in such a position as to be used both when the mobile phone is folded and open.

The above and other objects, features and advantages of the present invention will become apparent from the following description with reference to the accompanying drawings which illustrate examples of the present invention.

### BRIEF DESCRIPTION OF THE DRAWINGS

FIG. 1 is a perspective view of an open state of a folding mobile phone according to the present invention.

FIG. 2 is a perspective view of a closed state of a folding mobile phone according to the invention.

FIG. 3 is an explanatory view for explaining a switch.

FIG. 4 is an explanatory view for explaining a circuit of the switch.

FIG. 5 is a perspective view of a closed state of a folding mobile phone according to another embodiment of the invention.

FIG. 6 is a functional block diagram for explaining a retrieving function.

### DESCRIPTION OF THE PREFERRED EMBODIMENTS

Embodiments of the present invention will be described below by reference to the drawings.

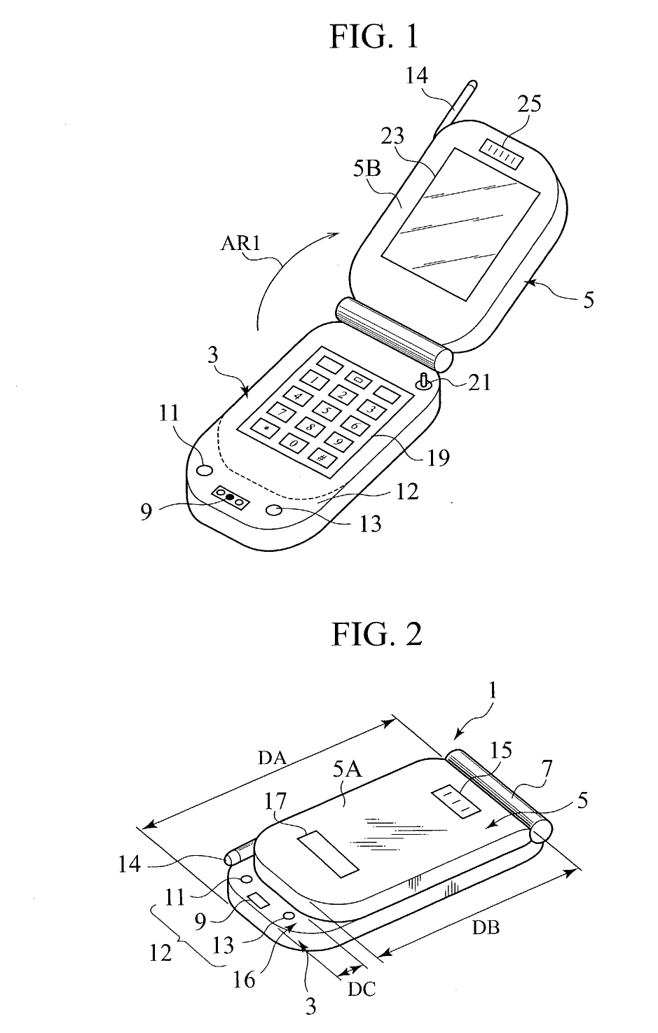

FIG. 1 is a perspective view of a state in which a first main body 3 and a second main body 5 are opened in a direction of an arrow AR1 from a folded state (see FIG. 2). In a folding mobile phone 1, the first main body 3 operated by a user of the mobile phone and the second main body 5 provided with a display 23 formed of liquid crystal or the like are connected to each other through a hinge mechanism 7 such that the phone 1 folds. In this embodiment, a folding mobile phone refers to a mobile phone in which the first main body 3 and the second main body 5 can be opened and closed through the hinge mechanism 7.

The first main body 3 is provided with a keyboard (first operating section) 19 having various functions such as input of numbers and characters. The first main body 3 also has a switch 21 and a second operating section 12 which will be described later. An antenna 14 is provided to a side portion of the second main body 5.

The second main body 5 is formed of an outside portion 5A (see FIG. 2) which is on an outside when the phone is folded and an inside portion 5B provided with the display 23. The inside portion 5B is also provided with a first earpiece (first loud speaker) 25 above the display 23. By using the first loud speaker 25, a user can use the mobile phone 1 in an open state.

FIG. 2 is a perspective view of a state in which the folding mobile phone 1 according to the present embodiment is folded. A longitudinal dimension DA of the first main body 3 is designed to be larger than a longitudinal dimension DB of the second main body 5. In other words, the first main body 3 has an extended section 16 formed to extend from the first main body 3.

As shown in FIG. 2, the second operating section 12 is provided to the extended section 16 where the first main body 3 and the second main body 5 do not overlap each other in a longitudinal direction in a folded state of the folding mobile phone 1. As can be understood from FIG. 2, a dimension DC of the extended section 16 is equal to a difference between dimensions DA and DB.

Various operating buttons and the like are provided on the second operating section 12 and, as a result, the mobile phone can also be used in the folded state. To put it concretely, the second operating section 12 is provided with a microphone 9 for a telephone conversation, a power on button 11 for bringing the mobile phone into a usable state, and a power off button 13 for bringing the mobile phone into an unusable state. On the outside portion 5A of the second main body 5, a second loud speaker 15 is provided. Further provided on the outside portion 5A is an external display panel 17 on which information about a party on the other end of the phone (e.g., a telephone number of the party) is displayed when the user gets an incoming call from the party. By the second loud speaker and the external display panel 17 in addition to the above-described second operating section, the user can use the mobile phone 1 and can know the information about the party from which the user gets the incoming call even in the folded state of the phone.

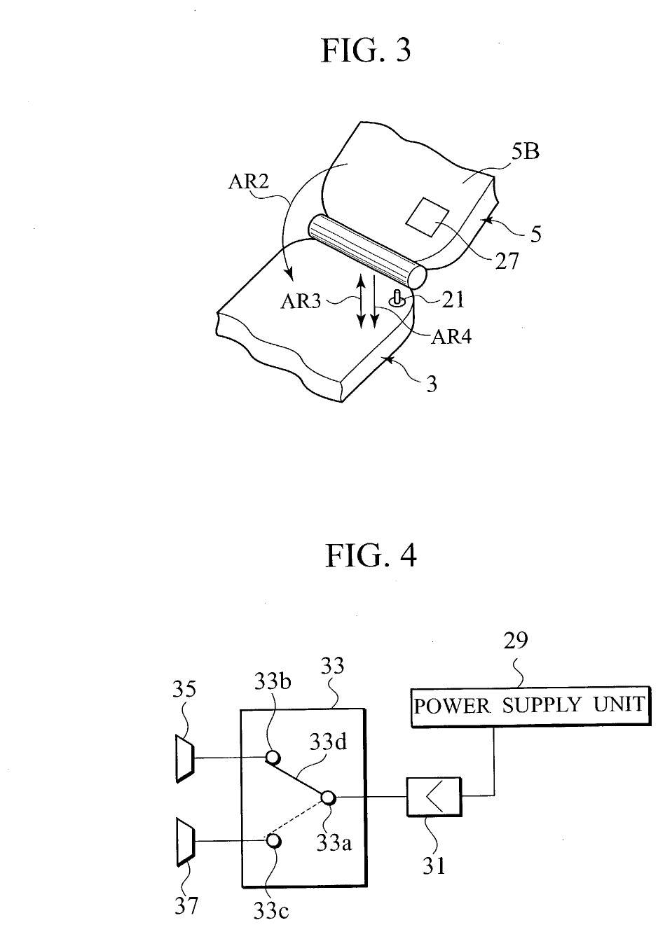

FIG. 3 shows a function of the protruding switch 21 for switching between ON/OFF of the first loud speaker 25 and the second loud speaker 15 in states in which the folding mobile phone 1 is folded and open. The protruding switch 21 is provided to be movable in a direction of an arrow AR3.

When the first main body 3 and the second main body 5 are closed in the direction of the arrow AR2, a protruding portion of the switch 21 is pushed against a switch contact portion 27 provided onto the inside portion 5B and, as a result, the protruding portion of the switch 21 is moved in a direction of an arrow AR4. At this time, power is switched between the first loud speaker 25 and the second loud speaker 15. In other words, when the folding mobile phone 1 is open, the switch 21 is not pushed against the switch contact portion 27 and power is supplied to the first loud speaker 25 in this state. In the folded state, the switch 21 is pushed by the switch contact portion 27, the first loud speaker 25 is turned off, and the second loud speaker 15 is turned on. Although the protruding portion of the switch 21 is housed inside the first main body 3 in the embodiment, other means may be employed as far as it is possible to control which of the first and second loud speakers is turned on in synchronization with opening and closing of the mobile phone 1.

FIG. 4 is a circuit diagram of the switch 21. Voltage supplied from a power supply unit 29 is amplified by an amplifier 31. As a result, volume or the like of the loud speaker 1 or the loud speaker 2 can be adjusted. A switch circuit 33 includes a terminal 33a, a terminal 33b, and a terminal 33c. When the folding mobile phone 1 is open (i.e., when the switch 21 is not in contact with the contact portion 27), a terminal 33d connects the terminal 33a and the terminal 33b. As a result, power is supplied to a first loud speaker circuit 35 to actuate the first loud speaker circuit 35 (i.e., the first loud speaker 25).

When the folding mobile phone 1 is closed (i.e., when the switch 21 is in contact with the contact portion 27), the terminal 33a and the terminal 33c are connected by the terminal 33d to thereby supply power to a second loud speaker circuit 37 to actuate the second loud speaker circuit 37 (i.e., the second loud speaker 15). As a result, when the first loud speaker 25 is turned on, the second loud speaker 15 is turned off. When the first loud speaker 25 is turned off, the second loud speaker 15 is turned on.

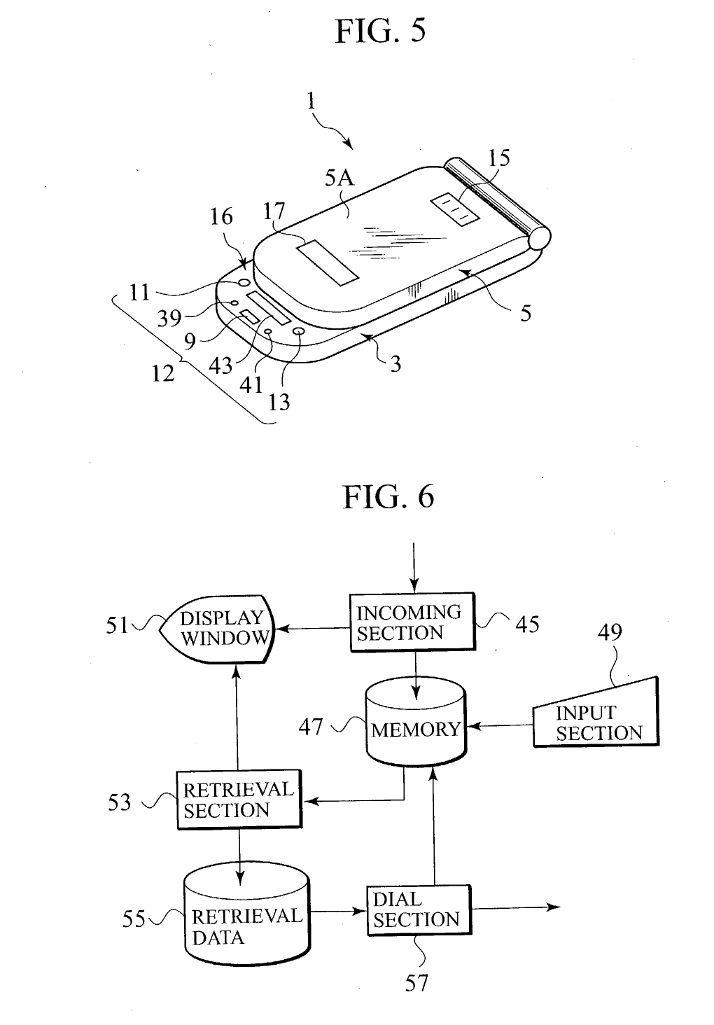

FIG. 5 shows another embodiment of the invention in which the second operating section 12 of the above-described folding mobile phone 1 is further provided with a call memory key 39 for manipulating information about incoming calls, a redial key 41 for manipulating information about outgoing calls, and a retrieval key 43 for retrieving the stored information in the mobile phone 1. As a result, it is possible to get an incoming call and make an outgoing call with the phone in the folded state.

FIG. 6 is a functional block diagram of the above-described respective functions. Information (e.g., a telephone number) about the incoming call received by an incoming section 45 is displayed on a display window 51 (corresponding to the external display panel 17 in FIG. 5) and stored in a memory 47. As a result, received address information of the party on the other end of the phone can be accumulated as a history.

On the other hand, a telephone number or the like keyed from an input section 49 (a first operating section 13 or a second operating section 13 in FIG. 5) is also stored in the memory 47. When the use of the mobile phone 1 calls the party, the user retrieves the address information stored in the memory 47 and makes an outgoing call. In retrieval, a retrieval section 53 (corresponding to the retrieval key 43 in FIG. 5) retrieves predetermined address information from the memory 47, stores it in retrieval data 55, and displays it on the display window 51. Then, buttons (e.g., buttons provided onto a keyboard 9 may be used for dialing) connected to a dial section 57 are pressed to dial. As a result, it is possible to answer a phone and to dial while closing the folding mobile phone 1. At this time, by selecting the call memory key 39 (e.g., press a button), information about the incoming calls can be retrieved. By selecting the redial key 41 (e.g., press a button), information about the outgoing calls can be retrieved.

The invention is not limited to the above-described embodiments and can be carried out in other modes by making proper modifications. For example, although longitudinal dimensions of the two main bodies (3, 5) are different in the embodiments, dimensions crossing the longitudinal direction may be different.

The dimensions of the two main bodies (3, 5) may be the same as far as the second operating section 12 and the second loud speaker 15 are provided on to the mobile phone 1. For example, in a state in which the mobile phone 1 is closed, the second operating section 12 may be provided onto the outside portion 5A having the second loud speaker. In this case, the longitudinal dimensions of the main bodies (3, 5) do not need to be different, which saves space.

What is claimed is:

1. A folding mobile phone comprising:
a first main body provided with a first operating section;
a second main body supported for opening and closing by a hinge mechanism on the first main body and having a display;
a first loud speaker provided in such a position as to be used when the mobile phone is open;
a second loud speaker provided in such a position as to be used when the mobile phone is closed; and
a microphone provided in such a position as to be used both when the mobile phone is folded and open.

2. A folding mobile phone according to claim 1 further comprising a switch for turning the first loud speaker off and turning the second loud speaker on when the folding mobile phone is folded and for turning the first loud speaker on and turning the second loud speaker off when the folding mobile phone is open.

3. A folding mobile phone according to claim 1, wherein a longitudinal dimension of the first main body is greater than that of the second main body and a second operating section is provided to a portion where the first main body and the second main body do not overlap each other when the folding mobile phone is folded.

4. A folding mobile phone according to claim 1,
wherein the second operating section includes:
a microphone section;
a power on button;
a power off button;
a call memory key;
a redial key; and
a retrieval key and
the second loud speaker is disposed on a back of the second main body.

5. A folding mobile phone comprising:
a first main body provided with a first operating section and a microphone; and
a second main body connected for opening and closing by a hinge mechanism to the first main body and having a first display and a first loud speaker,
wherein a length of the first main body is longer than that of the second main body, a second operating section is provided to a portion where the first main body and the second main body do not overlap each other when the mobile phone is closed, a second loud speaker is provided to an outside of the second main body.

6. A folding mobile phone according to claim 5 further comprising:
a protruding switch provided to the operating section main body for switching between the first loud speaker and the second loud speaker and
a switch contact portion which is provided on a side of the second main body facing the first main body and with which a protruding portion of the switch comes in contact,
wherein the protruding portion comes in contact with the contact portion, and power is supplied to the second loud speaker usable when the mobile phone is closed.

7. A folding mobile phone according to claim 6,
wherein the microphone is disposed in the second operating section,
the second operating section comprises:
a power on button;
a power off button;
a call memory key;
a redial key; and
a retrieval key, and
the second loud speaker is disposed on a back of the second main body.
